(19) United States
(12) Patent Application Publication
(10) Pub. No.: US 2022/0056878 A1
(43) Pub. Date: Feb. 24, 2022

(54) Solar-Powered Cyclic-Water Powered System

(71) Applicant: Dan Ragan Johnson, Sylvester, GA (US)

(72) Inventor: Dan Ragan Johnson, Sylvester, GA (US)

(21) Appl. No.: 17/000,290

(22) Filed: Aug. 22, 2020

(51) Int. Cl. F03B 13/06; H02S 10/10

(52) U.S. Cl. CPC F03B 13/06; H02S 10/10

(57) ABSTRACT

A Solar-Powered Cyclic-Water Powered System or composite machine comprising:

Solar panels for generating power from sunlight.
Pumps driven by power from said solar panels.
Tanks or reservoirs, upper and lower that store water or liquid.
Said pumps that move the water or liquid upward from lower level tanks or reservoir to the upper level tank or reservoir to be stored for later use. Both said tanks will hold an equal volume of water or liquid.
Channels, tubing or pipes thru which water or liquid flows.
Hydro turbines, thru which water or liquid will flow in a downward direction to generate electricity, after which water or liquid flows back to lower tank or reservoir to be reused again.
A solenoid valve that is used to start and stop the flow of water or liquid.
A switch that controls when said valve will open or close depending on voltage or power level of a battery to which it is connected.
A battery for storing electrical power, which in daylight hours would be charged directly from solar panels.
A battery charger to recharge the above mentioned battery.
Wiring, as indicated by positive and negative symbols and lines.

### BRIEF SUMMARY OR FIELD OF THE INVENTION

The present invention relates to serially mounted solar pumping devices and hydro turbines together wills storage tanks or reservoirs, all connected together by means of pipes, tubes or channels thru which water or liquid is circulated to produce electricity. Such devices are attached to a vertical structure such as a tower as shown in FIG. 1. During sunlight hours a finite amount of water or liquid, equal to the volume of one of the tanks or reservoirs, which can hold equal volume, is pumped thru such tubes up to the upper tank or reservoir to be stored for use when needed. This liquid or water can later be released to pass down thru the hydro turbine generators to produce electricity, after which it flows back to the lower level tank and is available to be recirculated again. This invention is unique in that a finite amount of water, connected as described above and as shown in FIG. 1 can be used in a cyclic manner to produce electricity an almost infinite number of times.

### BRIEF DESCRIPTION OF THE DRAWING

FIG. 1 is a side view of the Solar-Powered Cyclic-Water Powered System or composite machine that depicts all the devices and components of above mentioned system and how they all work together to store liquid in containment vessels and produce electricity when such liquid is released to pass thru hydro turbine generators. The same finite amount of liquid flows in a cyclic manner and Is thus used repeatedly.

### DESCRIPTION OF PREFERRED EMBODIMENTS

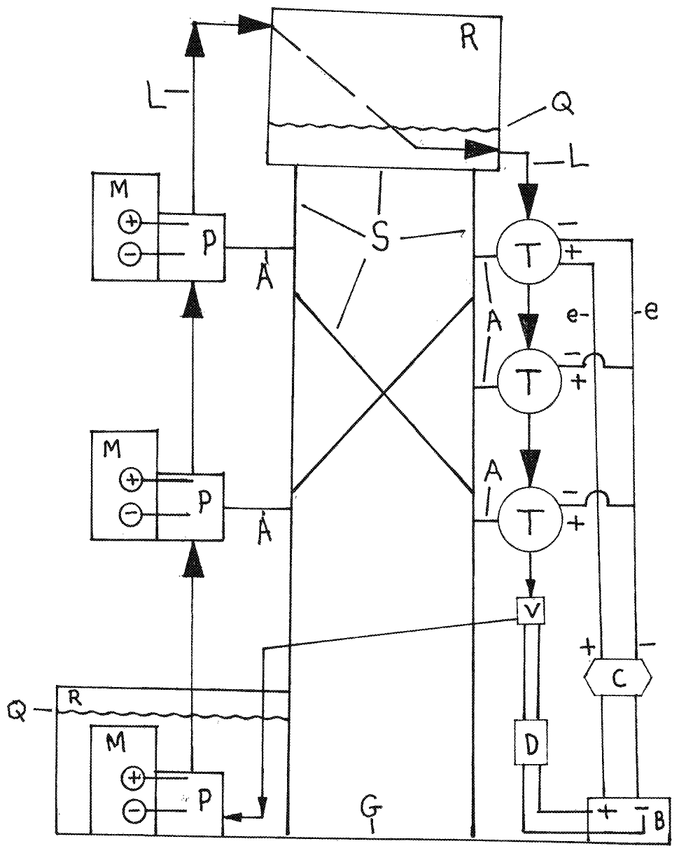

Upper and lower tanks or reservoirs R, both of which can hold the same volume of liquid or water according to a first embodiment of the invention as shown in FIG. 1. Solar cell panels M convert sunlight to electricity, which powers DC pumps P. Said pumps P push the water or liquid Q from the lower tank or reservoir R to the upper tank or reservoir R during sunlight hours. Said pumps P are equipped with floatation devices or other means detecting when water or liquid Q is present within the pumps P to ensure that pumps P do not run when no water or liquid is present within said pumps P. Said pumps P will in general be DC powered positive displacement devices, which tend to work slowly and efficiently. Upper level tank or reservoir R will retain or store the liquid or water Q until it will be released to flow during non-sunlight hours when needed. When needed, the water or liquid Q will now flow down thru tubes, pipes or channels L, with arrowheads indicating flow direction, to and thru the hydro turbine generators T, which will produce electric current which in this embodiment will be lower voltage DC current. The water or liquid Q will now flow thru the connected pipes, tubing or channel L back to the lower tank or reservoir R, where it where it will be available to be pumped or pushed back up again. Components P and T are mounted to the erect structure or tower S by attachment means A. Components M are connected electrically to component P via wiring e also indicated by (+) and (−) signs. An erect structure or tower S according to FIG. 1 is needed on which to mount other components. Components P (other than the lower or ground level P) and T will be mounted to the tower or erect structure E by attachment means A as shown in FIG. 1. The lower R, M, B and P components will rest on or near ground level G. The upper R will rest atop S as shown in FIG. 1.

Component C as shown if FIG. 1 is a DC to DC battery charger whose function is recharge the 12V battery B with power that it receives from the hydro turbine generators T via the electrical wires e also indicated by (+) and (−) signs. Battery B is also connected via wiring e to a low voltage disconnect switch D and said switch is in turn connected to a nominally closed solenoid V. The result being that when the battery B is fully or near fully charged the current thru the low voltage disconnect switch D will be allowed to pass thru to the valve V and keep it closed. However, when the voltage in the battery B drops below a pre-determined level the switch D will disconnect the power to the normally closed valve V and cause it to open and the water or liquid Q will now flow. The valve V will reopen when the battery B is sufficiently recharged.

The result is a closed-circuit circular flow of said liquid Q that is used to power the hydro turbines generators T.

As to a further discussion of the manner of usage and operation of the present invention, the same should be apparent from the above description. Accordingly, no further discussion relating to the manner of usage and operation will be provided.

With respect to the above description then, it is to be realized that the optimum relationships for the components of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What I claim is:

1. A Solar-Powered Cyclic-Water System or composite machine comprising: a vertical structure on which to attach other components and; components that are means to attach or mount said other components to said vertical structure and; two liquid containment vessels, one upper and one lower and; a liquid component that will flow in a cyclic manner to and from said containment vessels and; component(s) to force said liquid component in an upward direction and; components(s) that supply electrical power to said component(s) that force said liquid component in an upward direction and; components that directs said liquid component from said lower liquid containment vessel until it reaches said upper liquid containment vessel, where it is stored and; components to channel said liquid component in a downward direction and; component(s) to generate electric current from liquid component flow thru which said liquid component will flow downward and; a component that isolates input from output electrical current and; component thru which electrical current can flow, that connects from said component that generates electrical current to said component that isolates input from output electrical current and; a component that stores said electrical current or power and; component thru which electrical current can flow that connects from said component that isolates input from output electrical current, to component that stores electrical current or power and; component to turn electric current on or off and; component thru which electrical current can flow that connects from said component that stores electric current or power to said component that turns electrical current on or off and; a component that turns liquid component flow on or off and; component thru which electrical current can flow that connects from said component that turns electric flow on or off, to said component that turns liquid component flow on or off and; component that directs said liquid component from said component(s) that generate electrical current back to said lower liquid containment vessel.

2. A vertical structure according to claim 1, wherein said vertical structure is a natural structure such as a hill or tree.

3. A vertical structure according to claim 1, wherein said vertical structure is a wood, plastic or metal frame tower.

4. Components that are liquid containment vessels according to claim 1 are non-metal tanks.

5. Components that are liquid containment vessels according to claim 1 are clear or see-through tanks.

6. Liquid component that will flow according to claim 1 is fresh water.

7. Liquid component that will flow, according to claim 1 is anti-freeze or alcohol.

8. Component(s) to force said liquid component in an upward direction according to claim 1 are solar pumps.

9. Component(s) that are solar pumps according to claim 9, are 12 V DC powered solar pumps that can detect the presence of liquid so as to remain idle in the absence of said liquid within said pump.

10. Components that supply electric power to said solar pumps in claim 10 are solar panels that output 12V DC power.

11. Components that direct said liquid component from lower liquid containment vessel of claim 1 to said upper liquid containment vessel of claim 1 and from said upper liquid containment vessel according to claim 1 in a downward direction are hose, pipes or channels.

12. Components that generate electric current from said liquid component flow according to claim 1 are hydro turbine generators that output 12V DC power.

13. Component that isolates input from output electrical current according to claim 1 is a 12V DC-DC battery charger.

14. Component that stores said electrical power according to claim 1 is a battery.

15. Component that stores said electrical power according to claim 14 is a 12V DC battery.

16. Component thru which said electrical current can flow according to claim 1 is electrical wiring.

17. Component to turn electrical current on or off according to claim 1 is a low voltage cut-off switch.

18. Component that turns liquid component flow on or off according to claim 1 is a solenoid switch.

19. Components that direct said liquid component flow according to claim 1, from said components that generate electrical current according to claim 1, back to said lower liquid containment vessel according to claim 1 are hoses, pipes or channels.

20. Components that are means to attach or mount said other components to said vertical structure according to claim 1 are mounting hardware.
